(19) United States
(12) Patent Application Publication
(10) Pub. No.: US 2005/0140458 A1
(43) Pub. Date: Jun. 30, 2005

(54) Circuit which minimizes cross talk and reflections and method therefor

(75) Inventor: Clifford E. Clark, Knoxville, TN (US)

Correspondence Address: WEISS & MOY PC, 4204 NORTH BROWN AVENUE, SCOTTSDALE, AZ, 85251, US

(73) Assignee: CYTEK CORPORATION

(21) Appl. No.: 11/061,910

(22) Filed: Feb. 18, 2005

Related U.S. Application Data
(63) Continuation-in-part of application No. 10/160,465, filed on May 30, 2002.

(51) Int. Cl. H01P 3/08

(52) U.S. Cl. 333/1

(57) ABSTRACT

A printed circuit board to electrically couple electrical components has non-conductive layers. Conductive planes are formed on the non-conductive layers. Conductive traces are formed on the non-conductive layer to provide signal paths for the electrical components. Delay devices coupled to the conductive traces to space apart signals so as to minimize electric field effects on nearby signals.

### RELATED APPLICATION

This application is related to U.S. patent application having a Ser. No. of 10/160,465, filed May 30, 2002, in the name Clifford E. Clark as the inventor, and entitled “A PRINTED CIRCUIT BOARD (PCB) WHICH MINIMIZES CROSS TALK AND REFELCTIONS AND METHOD THEREFOR”. The above patent application is hereby incorporated by reference.

### FIELD OF THE INVENTION

This invention relates to semiconductor devices and, more specifically, to printed circuit boards (PCB) or circuit assemblies used to electrically connect components which will minimize cross talk between signals and minimize reflections of signals contained in a circuit assembly. Further, the effects of split planes may be minimized or negated.

### BACKGROUND OF THE INVENTION

Printed circuit boards (PCBs), also called printed wiring boards (PWBs) are used to electrically connect one or more electronic components. Electrical devices are usually attached to the top or bottom of the printed circuit board. Conductive material called a “trace” connects the electrical devices mounted to the printed circuit board. Conductive planes may be placed above or below the traces. The traces and the planes may be separated by a dielectric or a non-conductive material. The conductive planes may be used for a plurality of different purposes. For example, the conductive planes may be used as an electrical ground plane functioning as an electrical ground return path. The conductive plane may also be used as an electrical power plane functioning as a power distribution path. Together, the trace and plane provide a complete electrical path to and from electrical components associated with a printed circuit board. Generally speaking, traces typically connect signal paths of electronic components associated with a printed circuit board, while planes typically connect power or ground paths of electrical components associated with a printed circuit board. A cross-section of a simple example of a printed circuit board is depicted in FIG. 1.

Trace layers, dielectric or non-conductive layers, and plane layers may be repetitiously laminated to increase the number of traces available for connecting electrical components. A typical cross section of printed circuit board is shown below in FIG. 2.

Minimizing layers is desirable to reduce the cost of a printed circuit board. A power plane or ground plane may often be segmented or discontinuous. One segment of a plane may be used to distribute a voltage, while another segment is used to distribute a different voltage or to serve as an electrical ground. These segments may be coplanar. A segmented ground plane may provide a current path or current return path for more than one voltage. A typical cross section of printed circuit board with split planes is shown below in FIG. 3.

An electrical driver may electrically raise or lower a voltage value of an associated trace. The voltage value often corresponds to a logic value. As the electrical driver attempts to change the voltage value of the trace, a charging current propagates down the trace. A wave edge is created. The edge represents a change in current and a change in voltage. These changes are accompanied by electric fields. As the electric signal propagates down the trace, power or ground planes may provide a return path for current and electric fields. Electric fields produced by the propagating signal follow the signal down the trace. These electric fields may couple to nearby traces and induce an undesired artifact on other signals. See FIG. 4

The induced signals travel in approximately the same direction as the original signal when traces are approximately parallel. Proper design dictates spacing traces far enough apart to reduce or negate the undesired coupling when possible. See FIG. 5.

When power planes or ground planes are discontinuous (split, segmented), propagating signals that cross the split encounter a discontinuity in the conductive plane return path. The discontinuity affects the signal and the associated electric fields. As the leading edge of the signal approaches the area of a plane split, the associated electric fields spread away from the originating trace, and may induce an undesired signal on a nearby trace (See FIG. 6). Additional separation of the traces is usually impractical to avoid this increased coupling, since the area of the printed circuit board is limited and costly.

Electronic circuits receiving signals of effected traces may sample erroneous electrical values at their inputs. Sampling an erroneous value is undesirable. Another effect of the discontinuous plane is a change in the electrical impedance of the trace. Since geometry is a factor in the impedance of a trace, a change in geometry causes a change in the trace impedance. A change of impedance causes reflections of the propagating signal.

Therefore, a need existed to provide an improved circuit and method to overcome the above problem. The improved printed circuit board and method must minimize cross talk between signals.

### SUMMARY OF THE INVENTION

In accordance with one embodiment of the present invention, it is an object of the present invention to provide an improved electrical connector, such as a printed circuit board, and method to overcome the problems associated with the prior art printed electrical connectors.

It is another object of the present invention to provide an improved circuit and method that minimize cross talk between signals.

### BRIEF DESCRIPTION OF THE EMBODIMENTS

In accordance with one embodiment of the present invention, a printed connection board to electrically couple electrical components is disclosed. The printed circuit board has non-conductive layers. Conductive planes are formed on the non-conductive layers. Conductive traces are formed on the non-conductive layer to provide signal paths for the electrical components. Delay devices coupled to the conductive traces to space apart signals so as to minimize electric field effects on nearby signals.

In accordance with another embodiment of the present invention, an electrical interconnect is disclosed. The interconnect has a first signal line having a first driving device and a first receiving device. A second signal line is provided having a second driving device and a second receiving device. A first delay device is coupled to the first signal line to space apart a first signal on the first signal line from a second signal on the second signal line to minimize electric field affects. A second delay device is coupled to the second signal line to restore a time relationship between the first signal and the second signal.

### BRIEF DESCRIPTION OF THE DRAWINGS

FIG. 1 is a cross-sectional view of a prior art printed circuit board.

FIG. 2 are simplified rotated views of the prior art printed circuit board depicted in FIG. 1.

FIG. 3 are simplified rotated views of prior art printed circuit board with split planes.

FIG. 4 is a simplified diagram showing electric field coupling between traces on a prior art printed circuit board.

FIG. 5 shows a prior art printed circuit board which separates the traces to alleviate electric field coupling between nearby traces.

FIG. 6 shows a prior art printed circuit board which separates the traces to alleviate electric field coupling between nearby traces and how missing planes may cause electric field coupling between nearby traces.

FIG. 7 is a simplified functional block diagram of a prior art printed circuit board with interconnects.

FIG. 8 is a simplified view showing how signals cross a split plane on a prior art printed circuit board.

FIG. 9 is a simplified functional block diagram of a printed circuit board of the present invention.

FIG. 10 depicts the leading edge of signal 1 and signal 2 after a period of time T1.

FIG. 11 depicts the leading edge of signal 1 and signal 2 after a period of time T2.

FIG. 12 depicts the leading edge of signal 1 and signal 2 after a period of time T3.

FIG. 13 depicts the leading edge of signal 1 and signal 2 after a period of time T4.

FIG. 14 is a simplified block diagram of one embodiment of the printed circuit board of the present invention which minimizes reflections due to split planes.

FIG. 15 is an alternative embodiment for FIG. 13.

FIG. 16 is an alternative embodiment for FIG. 13.

FIG. 17 is a simplified block diagram of one embodiment of the printed circuit board of the present invention which minimizes cross talk.

FIG. 18 is a simplified block diagram of another embodiment of the printed circuit board of the present invention which minimizes cross talk.

FIG. 19 is a simplified block diagram showing electric field coupling between traces.

FIG. 20 is a simplified block diagram of one embodiment of the circuit of the present invention which reduces interaction between electromagnetic fields.

FIG. 21 is an alternative embodiment for FIG. 20.

FIG. 22 is an alternative embodiment for FIG. 20.

FIG. 23 is an alternative embodiment for FIG. 20.

FIG. 24 is an alternative embodiment for FIG. 20.

FIG. 25 is an alternative embodiment for FIG. 20.

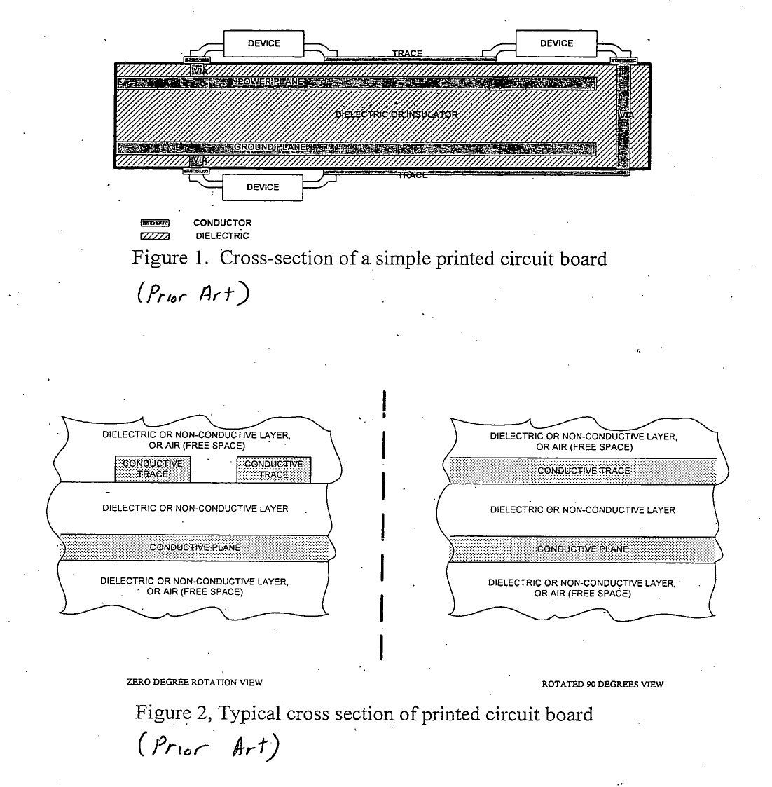

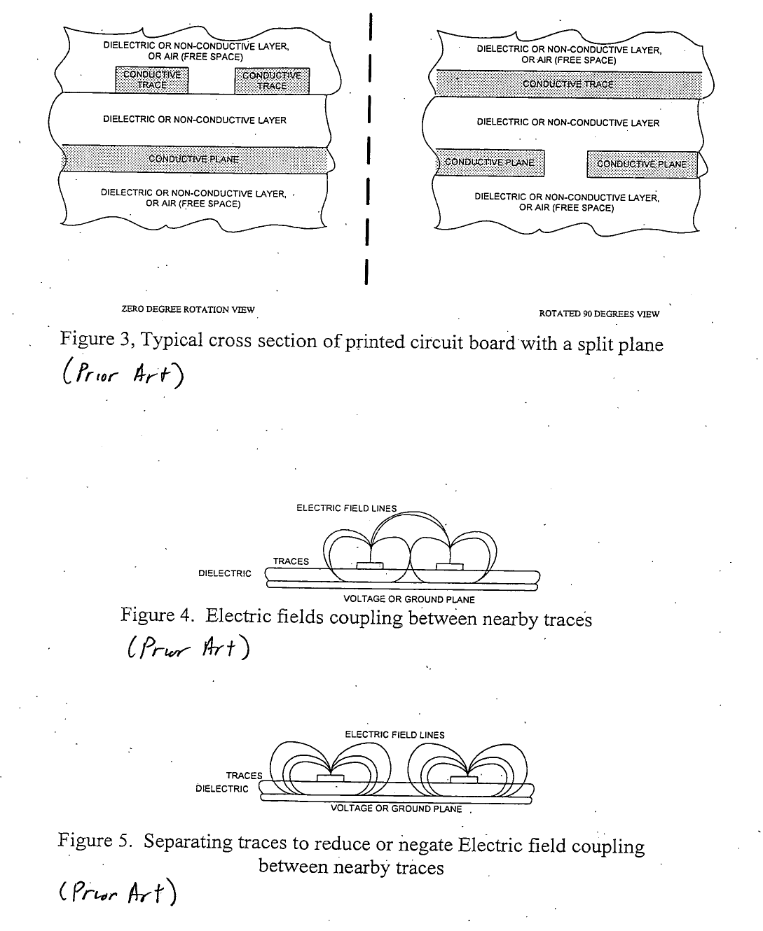

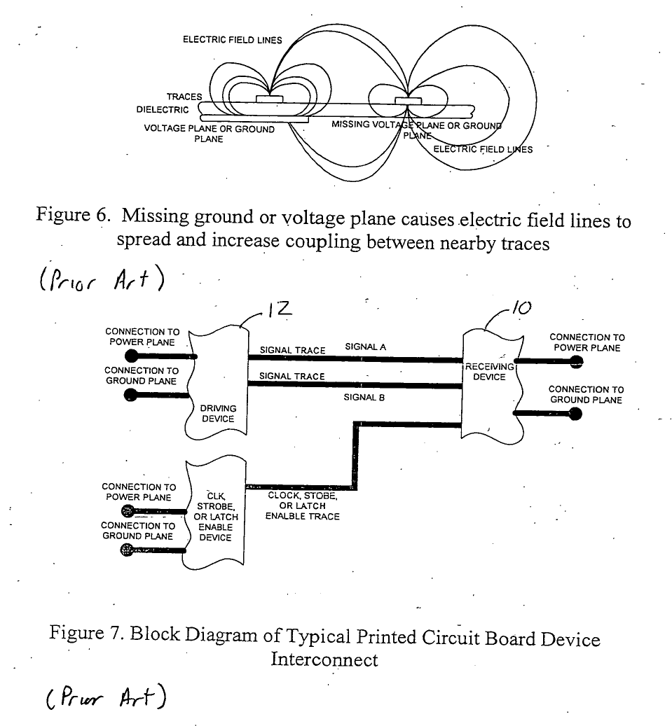

### DETAILED DESCRIPTION

Signals are typically sampled at a time when a receiving electronic component receives a second signal causing the first signals to be sampled. A signal that indicates when other signals are to be sampled is often referred to as “clock”, or “strobe”, or “latch enable”, or “latch”. Referring to FIG. 7, an electronic component sending signal “A”, signal “B” and a clock generator sending “clock” is shown. A receiving device 10 connects to signal A, signal B and Clk. Signal A and signal B are required to arrive at the receiving device 10 before Clk. The amount of time signal A and signal B is required to be valid before Clk is often referred to as “setup”. The amount of time signal A and signal B is required to be valid after Clk is often referred to as “hold”. Setup and hold times are specifications of the receiving device.

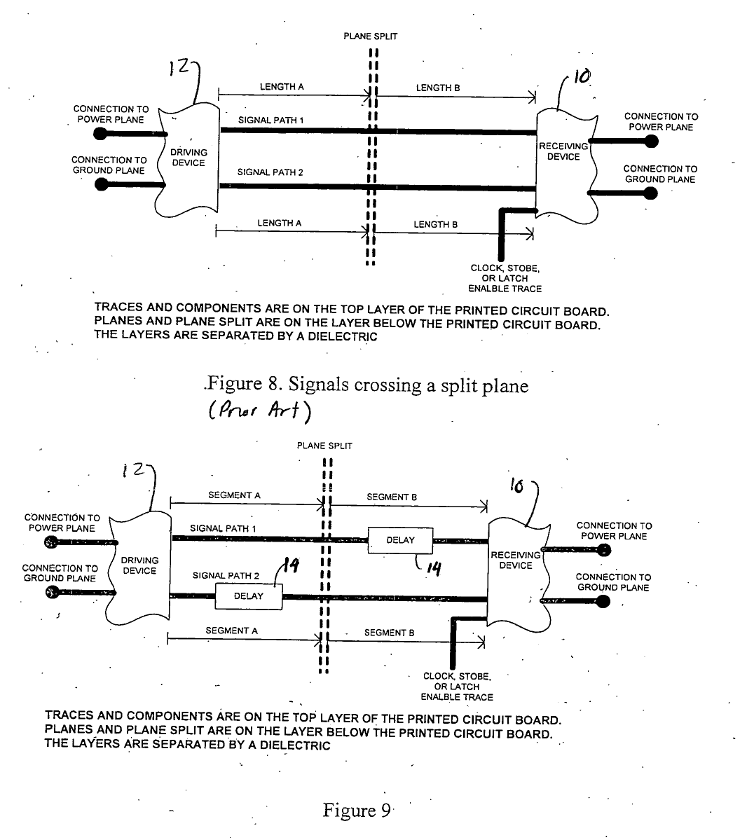

Referring to FIG. 8, two nearby signal paths are considered. Signals are launched from one or more driving device(s) 12 at approximately the same time. The signal edge propagates down their respective signal paths or traces. Electric fields follow the propagating signals. For length “A”, the traces are space sufficiently far apart so that their electric fields induce either an acceptable amount of signal artifacts from one trace to the other, or the signals induce no significant signal artifacts upon one another. Each signal path or trace retains the intended signal along length “A”. As signal 1 crosses the plane split, electric field lines from signal 1 expand near the split. The expanded electric fields from signal 1 electrically couple to signal path 2. The electric field from signal 1 induces an erroneous signal onto signal path 2. Signal 2 also induces an erroneous signal on signal path 1 at the discontinuity as well.

As signal 1 and signal 2 propagate across the plane split, artifacts induced from signal 1 to signal path 2 also propagate along signal path 2 to the end of segment “B” and arrive at the receiver. Likewise, the same thing occurs on signal path 1 due to signal 2 crossing the plane split.

Signals from path 1 and path 2 arrive at the receiver 10 within the time period that the receiver 10 samples these signal paths. The induced artifacts from signal 1 to signal path 2 arrive at the receiver IO within the time period that the receiver 10 samples these signal paths as well. The induced artifacts from signal 2 to signal path 1 also arrive at the receiver 10 within the time period that the receiver samples these signal paths.

It is desirable to minimize or negate the undesirable cross-talk effects of routing electrical signal paths over discontinuous (split) power planes or discontinuous (split) ground planes. This is due to the fact that signal paths that span discontinuous, split power planes or discontinuous, split ground planes may couple their signals to nearby signal paths. Undesirable, erroneous signal artifacts may be sampled by receiving devices when erroneous signals are induced on a nearby signal path. To reduce or remove the possibility that an erroneous signal is sampled, the erroneous signal can be moved outside of the time period when intended signals are sampled.

One may conclude that the following design method will break timing constraints of the systems where the method is intended to be used. However, one should understand that trace lengths are commonly matched to reduce timing skew. Hence, this method of design may be implemented within the length of traces added for length matching. This method of design may also be implemented within delays existing elsewhere in an electrical system. The described design method may be used with little or no impact on the timing constraints of the system.

The described design method implements delays in signal paths at locations that move the erroneous signal artifacts outside of the time period when signals are sampled. In the following embodiment, a delay is implemented on the printed circuit board external to the driving or receiving agents. However, this should not be seen as to limit the scope of the present invention. The delay may also be implemented internal to the driving or receiving agents.

Now referring to FIG. 9, a delay 14 is inserted on signal path 1 in segment B and a delay 14 on segment A of signal path 2. The delay 14 on signal path 1 is approximately equal to the delay 16 on signal path 2. Signals are launched from a driving device 12 or driving devices 12 at approximately the same time. The signal wave propagates down their respective paths. Electric fields follow the leading edge of propagating signals.

Along length “A”, the signals or traces are spaced sufficiently far apart so that their electric fields induce either no signal artifacts upon one another or induce an acceptable amount of signal artifacts from one trace to the other. Each signal path retains the intended signal along segment “A”.

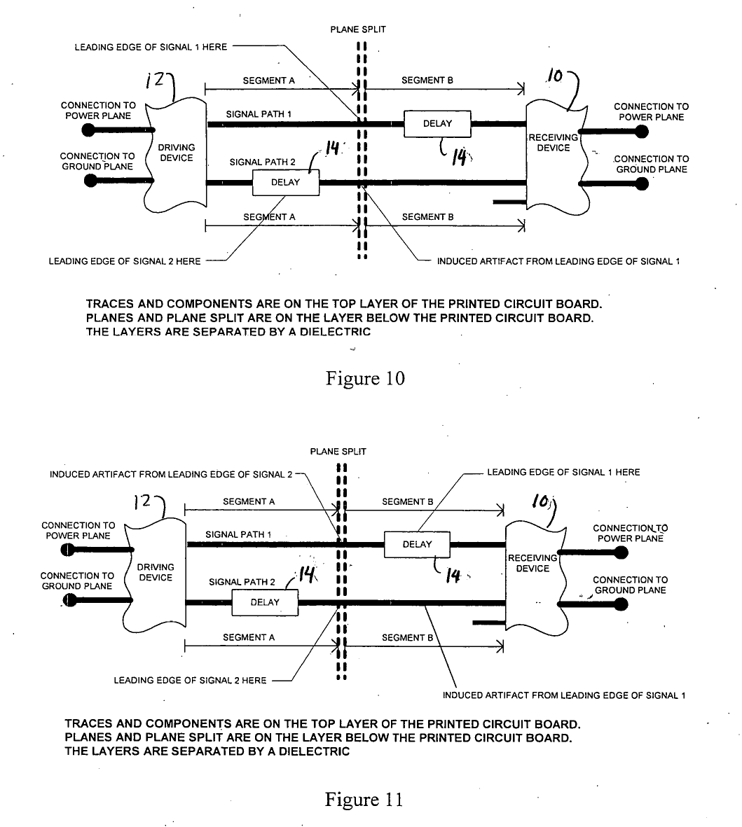

However, since delay 14 is encountered on signal path 2 in segment “A”, the leading edge of signal 1 on path 1 crosses the split plane first. So, the leading edge of signal 1 induces artifacts on signal path 2 before the leading edge of signal 2 reaches the split plane (See FIG. 10).

Later, the wave front of signal 2 on signal path 2 crosses the split plane and induces artifacts on signal path 1. However, the wave front of signal path 1 has already passed the split. The induced signal on path 1 from signal 2 is behind and separated from the wave front of signal 1 (See FIG. 11).

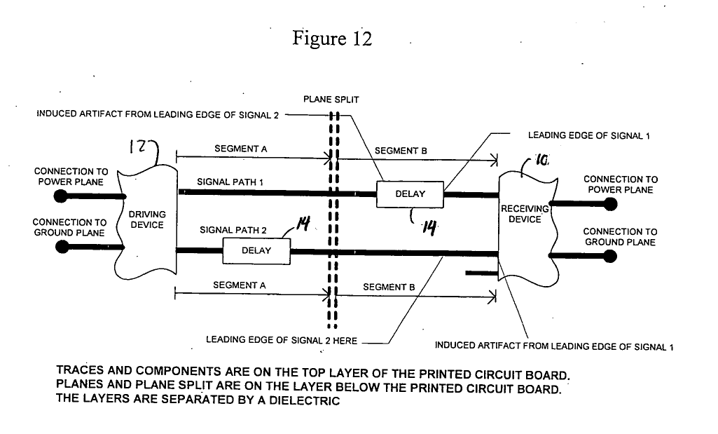

The wave front of signal path 1 now encounters delay 14 on segment “B” of signal path 1. The induced artifact caused by the wave edge on signal path 1 is now propagating on signal path 2. The induced artifact on signal path 2 does not encounter delay 14 segment “B” and arrives at the receiver ahead of the wave edge on signal path 1 (See FIG. 12).

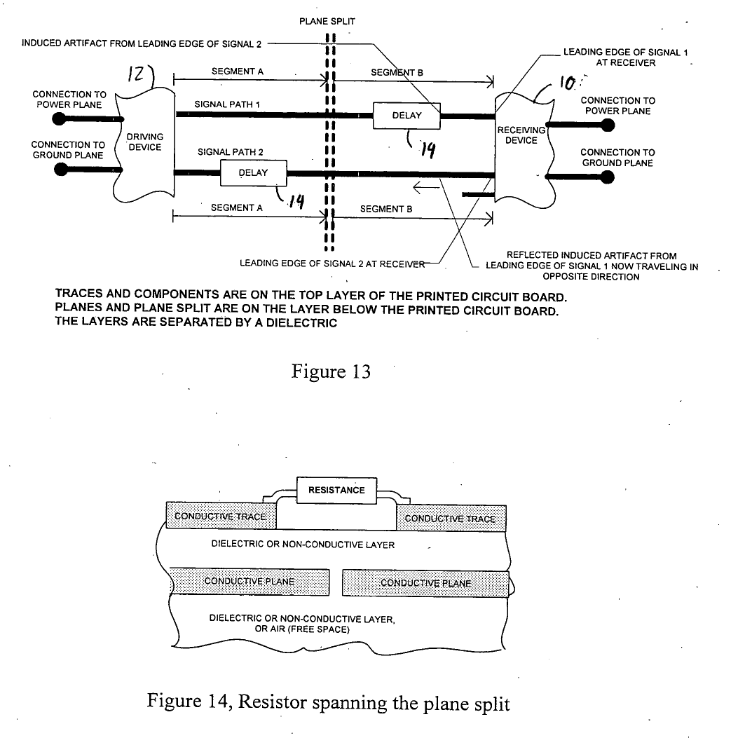

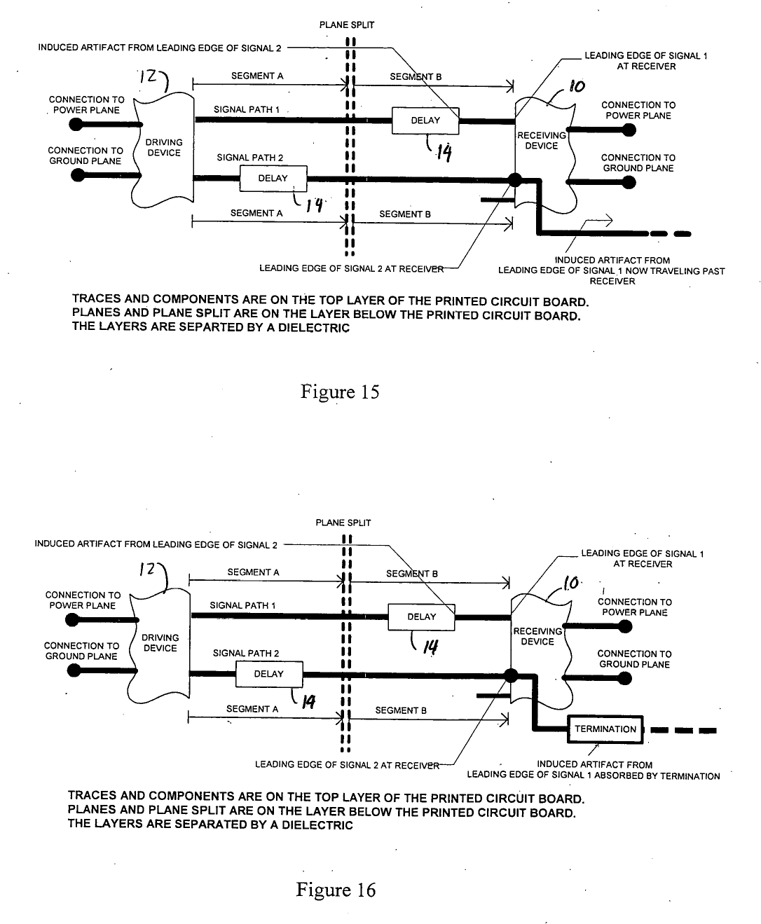

If signal path 2 ends at the receiver, a reflection of the artifact may be sent back in is the direction of the driver 12. If signal path 2 is terminated at the signal path impedance, no reflection occurs. If the signal path 2 continues, the artifact continues to propagate pass the receiver 10 (See FIG. 13, FIG. 14, FIG. 15).

Since signal path 2 has no delay element on segment B, the leading edges of the intended signals arrive at the receiver 10 at approximately the same time. Recall that path A and path B have approximately the same amount of delay 14 each. The induced artifact is now some distance away from the receiver 10 traveling away from the receiver or its reflection has been absorbed by proper termination of the signal path. If the value of delay 14 is chosen so that the amount of time is greater than sample period of the receiver 10, no artifact will be sampled at the receiver 10.

Recall that the wave front on signal path 2 crossed the plane split “delay” time after the wave front of signal path 1. So, the wave front on signal path 2 induces an artifact on signal path 1 “delay” behind wave front of signal path 1. This second artifact also propagates on signal path 1. However, artifact 2 reaches the receiver 10 on path 1 sometime after the wave fronts on either signal path 1 or signal path 2. If the value of delay 14 is chosen so that the amount of time is greater than the sample period of the receiver I0, no artifact will be sampled at the receiver 10 whether artifact 2 is reflected or absorbed.

This method of design can be used to move artifacts out of the sample period of a receiver 10 whether signal path 1 crosses a plane split, signal path 2 crosses a plane split, or multiple signal paths cross a plane split. The design method may be used to negate undesirable induced signals from other than split plane origin.

Implementation of delay 14 can be accomplished externally or internally to the driving agent 12 or receiving agent 10. Although the method of delay 14 is unimportant, suggested implementation of external delays 14 may consist of lengths of conducting trace or signal path, delay lines, logic elements, capacitance, or other circuit elements that exhibit delay. Suggested internal delays 14 may consist of lengths of internal interconnect, delay lines, logic elements, capacitance, or other circuit elements that exhibit delay.

If the trace continues past the receiver 10, the erroneous signal induced from a nearby trace travels away from the receiver 10 in the original direction. This possibility is depicted in FIG. 15.

If the trace is properly terminated near the receiver 10, the erroneous signal does not reflect. This possibility is depicted in FIG. 16.

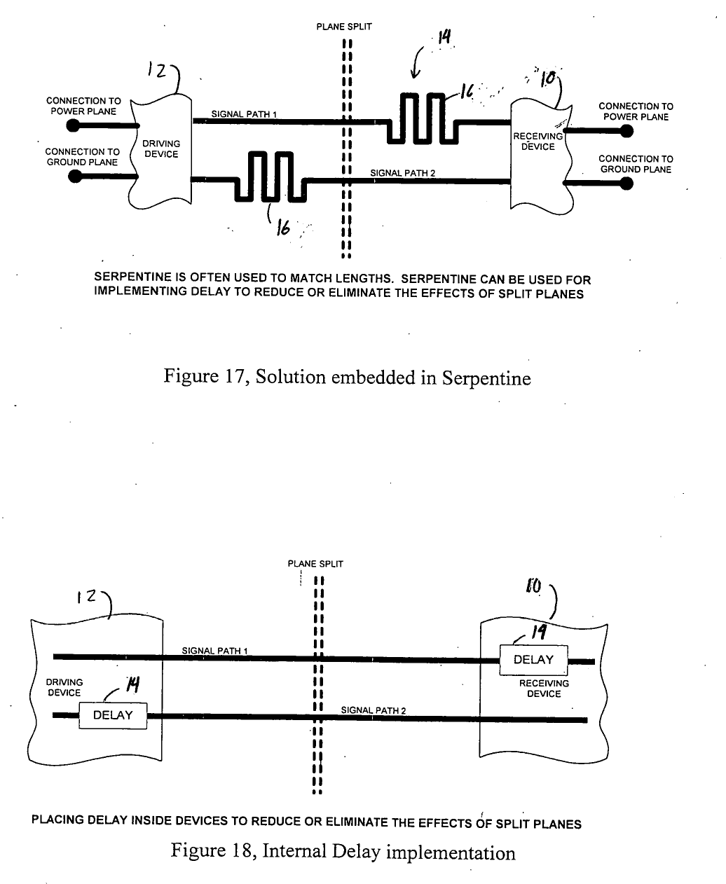

There are several ways for implementing delay. FIG. 17 depicts delay implemented externally to either the driving 12 or receiving devices 10. Serpentine traces 16 are one way for implementing delays 14. What makes this approach novel is alternating the serpentine 16 on nearby traces to different sides of the split plane. The alternation of delay 14 creates the aforementioned solution. To avoid additional system delay, embed the aforementioned solution into planned serpentine.

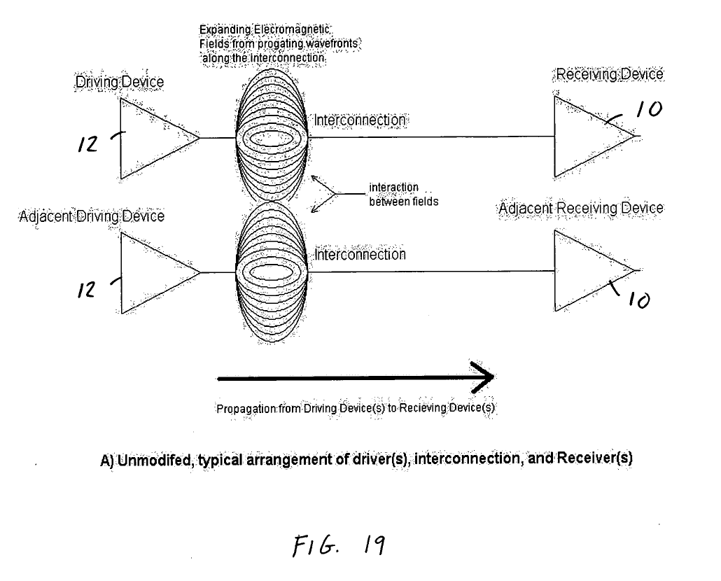

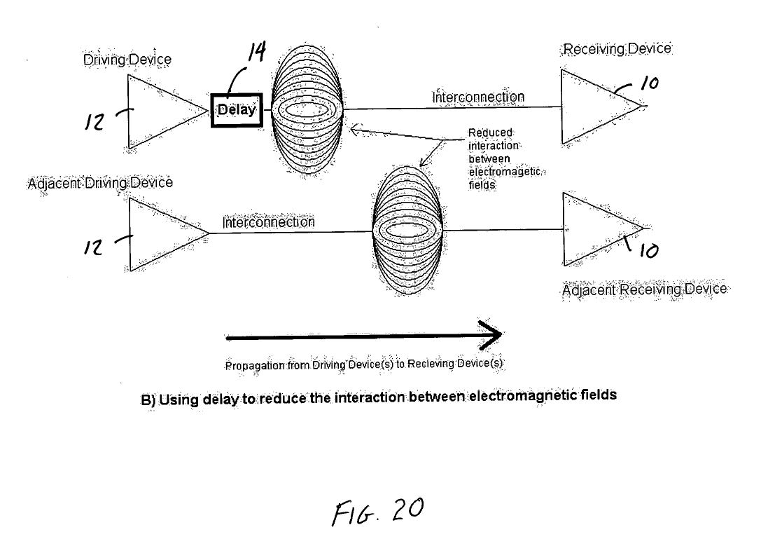

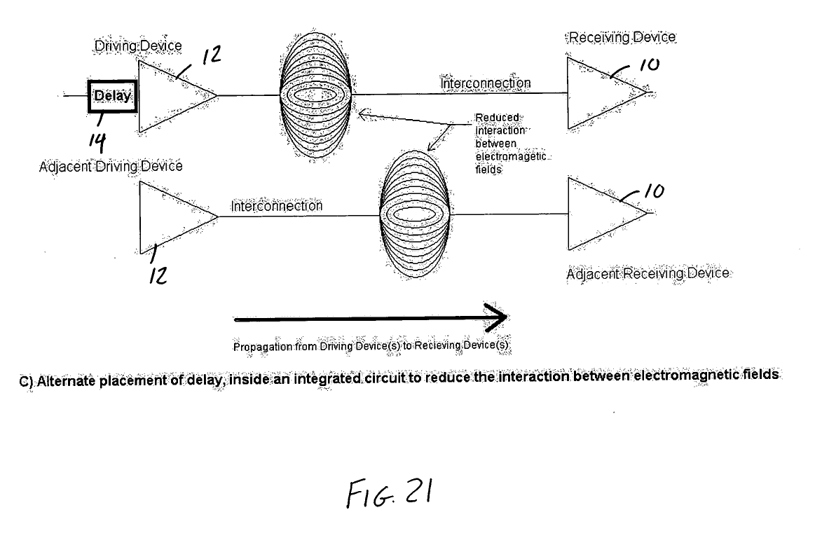

Delay may also be implemented internally to the receiving 10 or driving devices 12. Refer to FIG. 18, an internal delay 14 implementation is shown. A combination of different types of implementation can be used to affect the aforementioned solution.

The geometry of the cross-section of circuit boards influences the characteristic impedance of the traces that comprise the circuit board. This geometry is changed abruptly when a plane split occurs. The abrupt impedance change creates reflections of signals that are referenced to the plane segments. It is desirable to minimize or negate the undesirable reflection effects of routing electrical signal paths over discontinuous, (split) power planes or discontinuous, (split) ground planes.

Although resistive devices have been used to match electrical impedance, their use to minimize the effects of split planes is novel and somewhat more complicated. A geometrical constraint must be met for a resistive device to minimize reflections. The abrupt impedance change caused by signals spanning split planes can be minimized or negated by interrupting the trace and substituting a resistor or device performing the function of a resistor that spans across the plane split, electrically connecting one part of the trace with the other. The device's resistance value should be the same or nearly the same as the characteristic impedance of the trace. Of new and novel importance, the physical length of the resistor must be greater than the plane split and any fringing effects (spreading of electric fields) to provide consistent impedance across the split.

To minimize the possibility of distortion to the signal caused by the resistor, low inductance resistors are best used. Resistive devices may be placed in parallel to reduce their inductance. The resistor minimizes or negates the impedance change due to discontinuous planes. In place of a resistor, a device may be used that performs a similar function as a resistor. Such devices include various types of transistors, etc.

The described methods of design can be used to prevent undesirable artifacts from being sampled at a receiving agent. Agents other than discontinuous split planes may cause these undesirable artifacts. The artifact may be separated from the desired event by a delay greater than the sampling period of the receiver.

The above circuit and methods will also work where planes are not split. Referring to FIG. 19, in a typical electronics system, driving agents 12 located within one integrated circuit, drive their electronic signals through an “interconnect”, to a receiving agent 10 located in another integrated circuit. As the propagating signals move through the interconnects, the wave front creates expanding electromagnetic fields. Expanding electromagnetic fields interact with other, nearby electromagnetic fields. This interaction is largely undesired. Within a single integrated circuit, there maybe many driving agents and receiving agents interconnected. These interconnects are also problematic in that their signals may have undesired interaction with other nearby electromagnetic field produced by other signals. However, for the purpose of illustration, driving agents, and receiving agents are shown in separate integrated circuits.

Referring now to FIG. 21, a delay 14 may be inserted in a signal path to separate in time and space, the electromagnetic fields from other electromagnetic fields. The delay 14 can be inserted in various places along the signal path to accomplish separation of electromagnetic fields. As shown in FIG. 21, the delay 14 is added just after the driving agent 12 of the first signal line. However, as stated above, delay 14 can be inserted in various places along the signal path to accomplish separation of electromagnetic fields.

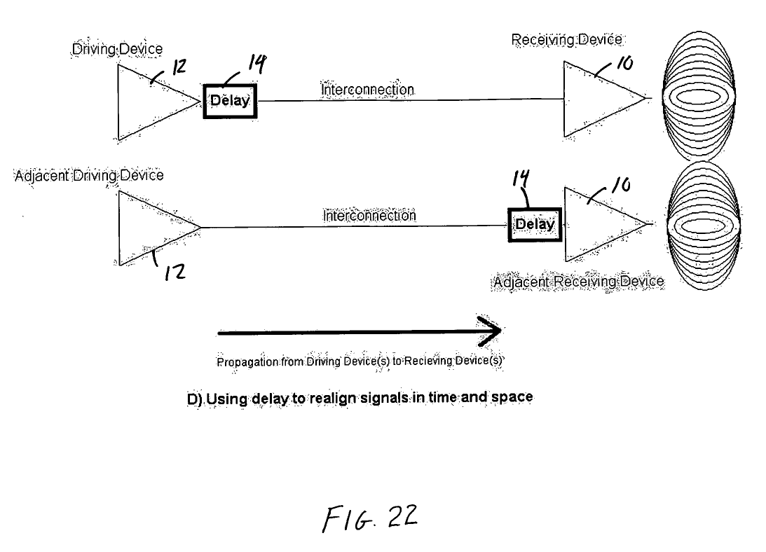

As may be seen in FIG. 22, the delay 14 can be inserted before the driving buffer 12 on one of the signal lines. By delaying the signal, one may reduce the interaction between electromagnetic fields as shown in the Figure.

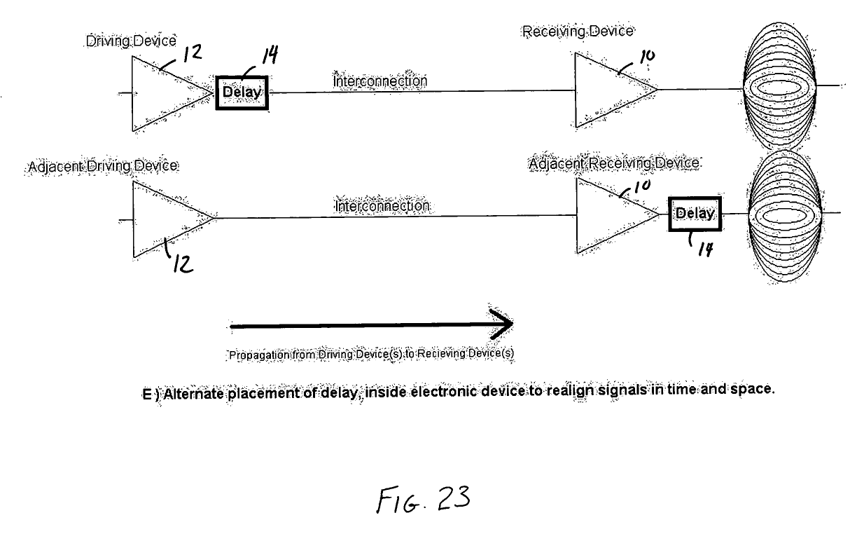

Referring now to FIG. 23, if a delay 14 is inserted into one signal path, the time relationship between this signal and other signals is changed. To restore the time relationship of one signal to another, another delay 14 is added to the other signal path at a point where the time relationship is intended to be restored. As may be seen in FIG. 23, the time relationship is restored after the delay element 14 shown in the bottom signal path. Within this context, interaction of electromagnetic fields is reduced along the interconnection between the driving and receiving agents.

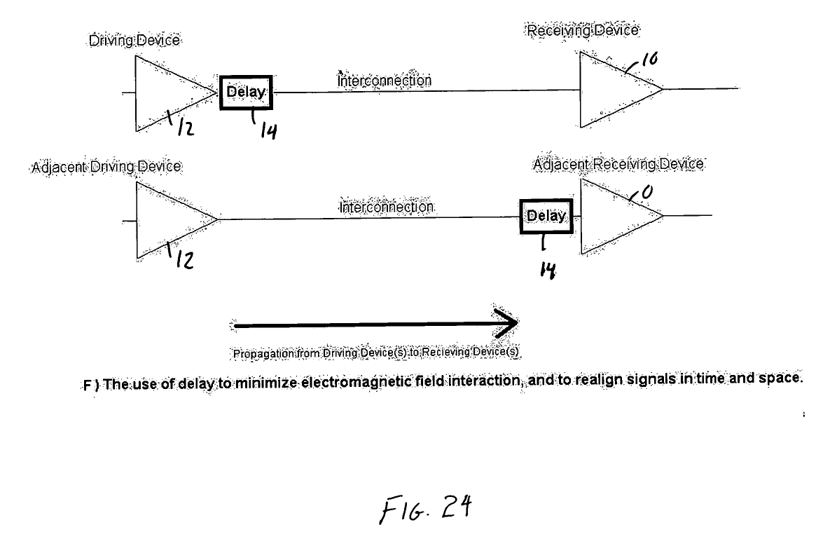

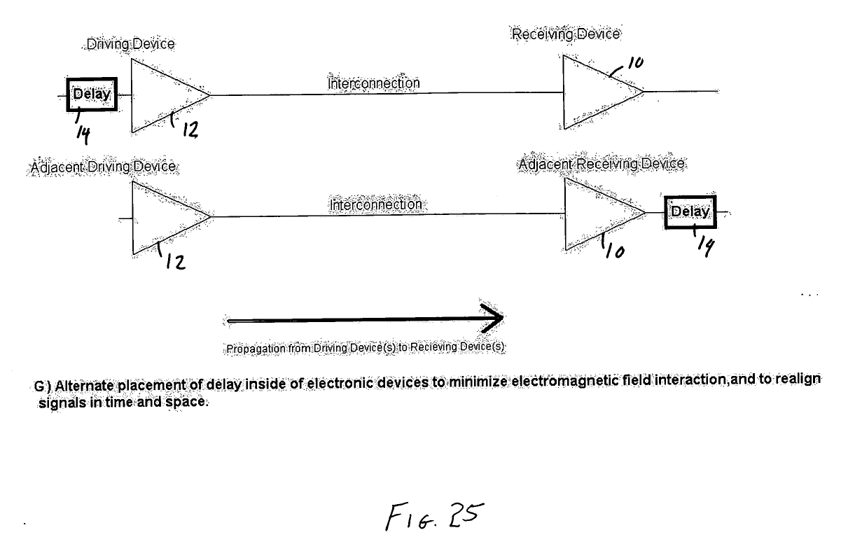

Many different placements of the delay 14 can be used to reduce interaction of electromagnetic fields. Many different placements of the delay 14 can be used to restore the time relationship between one signal and other signals. In FIG. 24, the delay 14 for reducing field interaction is placed after the driving buffer element 14. This could be inside or outside of the driving integrated circuit. A delay 14 used to restore the time relationship between the two illustrated signals is placed after the receiving buffer 10 of the receiving integrated circuit.

In FIG. 25, the delay 14 to reduce interaction of fields is placed after the driving buffer 12 of the driving agent. The placement could be inside or outside of the integrated device containing the driving buffer 12. The delay 14 used to restore the time relationship between the two signals is placed before the receiving buffer 10. The placement could be inside or outside the integrated device containing the receiving device 10.

In FIG. 26, the delay 14 to reduce interaction of fields is placed before the driving buffer 12 of the driving agent. The placement is inside of the integrated device containing the driving buffer 12. The delay 14 used to restore the time relationship between the two signals is placed after the receiving buffer 10. The placement is inside the integrated device containing the receiving device 10.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

1. A printed circuit board to electrically couple electrical components comprising:
non-conductive layers;
conductive planes formed on the non-conductive layers;
conductive traces formed on the non-conductive layer to provide signal paths for the electrical components; and
delay devices coupled to the conductive traces to space apart signals so as to minimize electric field effects on nearby signals.

2. A printed circuit board to electrically couple electrical components in accordance with claim 1 wherein the delay device is internal to a driving device which is coupled to the printed connection board.

3. A printed circuit board to electrically couple electrical components in accordance with claim 1 wherein the delay device is internal to a circuit assembly which is used to electrically connect components.

4. A printed circuit board to electrically couple electrical components in accordance with claim 1 wherein the delay device is external to a driving device which is coupled to the printed connection board.

5. A printed circuit board to electrically couple electrical components in accordance with claim 1 wherein the delay device is external to a receiving device which is coupled to the printed connection board.

6. A printed circuit board to electrically couple electrical components in accordance with claim 1 wherein the delay devices offset then realign wave edges of the signals so as to minimize electric field effects on nearby signals.

7. An electrical interconnect comprising:
a first signal line having a first driving device and a first receiving device;
a second signal line having a second driving device and a second receiving device;
a first delay device coupled to the first signal line to space apart a first signal on the first signal line from a second signal on the second signal line to minimize electric field affects; and
a second delay device coupled to the second signal line to restore a time relationship between the first signal and the second signal.

8. An electrical interconnect in accordance with claim 1 wherein the first delay is positioned before the first driving device.

9. An electrical interconnect in accordance with claim 1 wherein the first delay is positioned after the first driving device and the second delay is positioned before the second receiving device.

10. An electrical interconnect in accordance with claim 1 wherein the first delay is positioned after the first driving device and the second delay is positioned after the second receiving device.

11. An electrical interconnect in accordance with claim 1 wherein the first delay is positioned before the first driving device and the second delay is positioned before the second receiving device.

12. An electrical interconnect in accordance with claim 1 wherein the first delay device is internal to the first driving device.

13. An electrical interconnect in accordance with claim 1 wherein the first delay device is external to the first driving device.

14. An electrical interconnect in accordance with claim 1 wherein the second delay device is internal to the second receiving device.

15. An electrical interconnect in accordance with claim 1 wherein the second delay device is external to the second receiving device.

16. An electrical interconnect comprising:
a plurality of signal lines wherein each signal line has a driving device and a receiving device;
a first delay device coupled to a first signal line to space apart a first signal on the first signal line from a second signal on an adjacent signal line to minimize electric field affects; and
a second delay device coupled to the adjacent signal line to restore a time relationship between the first signal and the second signal.

17. An electrical interconnect in accordance with claim 16 wherein the first delay is positioned after the driving device on the first line and the second delay is positioned before the receiving device on the adjacent signal line.

18. An electrical interconnect in accordance with claim 16 wherein the first delay is positioned before the driving device on the first line and the second delay is positioned before the receiving device on the adjacent signal line.

19. An electrical interconnect in accordance with claim 16 wherein the first delay is positioned after the driving device on the first line and the second delay is positioned after the receiving device on the adjacent signal line.

20. An electrical interconnect in accordance with claim 16 wherein the first delay is positioned before the driving device on the first line and the second delay is positioned after the receiving device on the adjacent signal line.
